(19) United States
(12) Patent Application Publication
(10) Pub. No.: US 2009/0187643 A1
(43) Pub. Date: Jul. 23, 2009

(54) System and Method for Configuring Networked Enterprise Information Handling System Solutions From a Product and Options Template

(76) Inventors: Hang Ng, Austin, TX (US); Jason Wallis, Round Rock, TX (US); Sreenivas Sathyanarayana, Austin, TX (US); Jayavel Somasundaram, Austin, TX (US); Ojas Patel, Pflugerville, TX (US)

Correspondence Address: HAMILTON & TERRILE, LLP, P.O. BOX 203518, AUSTIN, TX, 78720, US

(21) Appl. No.: 12/018,324

(22) Filed: Jan. 23, 2008

(51) Int. Cl. G06F 15/177

(52) U.S. Cl. 709/220

(57) ABSTRACT

Networked enterprise information handling system solutions are configured by reference to a components template having plural components, each component having one or more associated attributes, such as in an XML structure. A selector interface provides end user access to the component template to accept end user inputs for products and constraints. A configuration engine applies selected products and constraints to products and constraints of the component template to automatically generate an enterprise solution of networked information handling systems.

### BACKGROUND OF THE INVENTION

1. Field of the Invention

The present invention relates in general to the field of information handling system interactions, and more particularly to a system and method for configuring networked enterprise information handling system solutions from a product and option template.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Business enterprises have come to rely upon information handling systems in order to perform enterprise functions in an effective and efficient manner. One result of the growing reliance of enterprises on information handling systems is that enterprises have generated and continue to generate large quantities of information that needs management and storage. In response to increased enterprise storage needs, industry has developed a variety of enterprise solutions that manage and store information with networked information handling systems and supporting devices, such as networked hard disk drives. Generally, enterprises prefer enterprise solutions that are scalable so that additional management and storage devices are added as needed to provide rapid access to information when the information is needed. Another feature commonly sought by enterprises is redundancy, such as by keeping multiple copies of information within a storage solution so that failure of any one storage device will not make information inaccessible. One type of enterprise storage solution often preferred by enterprises is a storage area network (SAN). SANs are often interfaced with Fibre channel cables that provide for rapid communication of information between storage devices through host bus adapters (HBAs), Fibre channel switches and disk or storage processor enclosures (DPEs or SPEs). SANs are typically deployed in redundant or non-redundant topologies. Another type of enterprise storage topology is direct attached storage (DAS).

One difficulty that enterprises face in setting up and using networked enterprise information handling system solutions is configuring components of a solution in a compatible manner. For example, different combinations of HBAs, switches, DPEs and SPEs call for different types of cables for connecting devices. Often, when ordering networked information handling system enterprise solutions, end users have confusion about the types of components to select and how the selected components will interconnect. An overall enterprise solution is often difficult for end users to visualize since an enterprise solution often includes large numbers of components. In the event that an end user purchases incompatible components, such as incorrect cables, the end user often blames the incompatible components on the information handling system manufacturer. Active management of a customer order by manufacturer sales representatives tends to increase the probability of generating a valid enterprise configuration by reducing such errors; however, even highly-trained representatives have difficulty keeping track of appropriate components. Further, active involvement by a manufacturer representative also increases the cost of completing enterprise orders since manual selection and validation of an enterprise solution is time consuming. Automation of the configuration of enterprise solutions is difficult given the variety of components involved and frequent updates made to these components by their manufacturers.

### SUMMARY OF THE INVENTION

Therefore a need has arisen for a system and method which aids automation of end user configuration of information handling system enterprise solutions by tracking a plurality of components available for the configuration and the compatibility of the components with each other.

In accordance with the present invention, a system and method are provided which substantially reduce the disadvantages and problems associated with previous methods and systems for tracking a plurality of components available for the configuration of information handling system enterprise solutions. A component template tracks attributes of components. Configuration of an enterprise solution interconnects plural information handling systems with compatible components by reference to the attributes.

More specifically, a component template built from an XML schema associates information handling system components with attributes so that a configuration engine can apply the attributes to define an enterprise information handling system networked information handling systems, component options, such as interconnection devices for server information handling system, and constraints, such as the types of components and component options used in a selected component, such as CPU or memory capability or the type of topology that components are used in to build an enterprise solution. A selector interface accepts end user selections of components, options and constraints which the configuration engine applies to the component template to suggest components that will build an enterprise solution for the end user. The component template is refined to narrow down the components, such as products, options and constraints, which are used to build an enterprise solution.

The present invention provides a number of important technical advantages. One example of an important technical advantage is that a plurality of components for use by end users to configure information handling system enterprise solutions are effectively and efficiently tracked by product, option and constraint attributes in a solution template. The solution template is an XML structure maintained through a graphical user interface to readily accept updates for new requirements so that requirements are effectively decoupled from component products. This simplifies end user purchases of enterprise solutions and provides a favorable end user experience with decreased risk that an enterprise solution will ship with incompatible components and increased likelihood that an ordered enterprise solution will offer optimal performance for a given price point.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a networked information handling system enterprise solution;

FIG. 2 depicts a block diagram of a system for generating enterprise solutions from a component template;

FIG. 3 depicts a flow diagram of a process for generating enterprise solutions from a component template; and

FIGS. 4A-4G, generally referred to herein as FIG. 4, depict examples of an XML schema for a component template.

### DETAILED DESCRIPTION

Networked information handling system enterprise solutions are generated from a component template that is easily maintained with regular updates to satisfy changing requirements. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

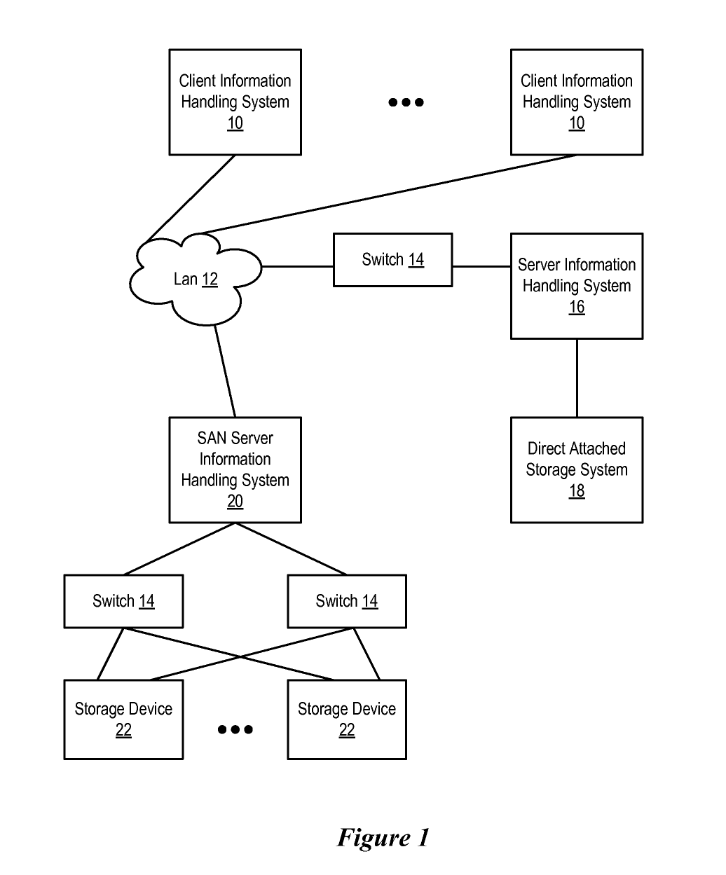

Referring now to FIG. 1, a block diagram depicts a networked information handling system enterprise solution. Plural client information handling systems 10 interface through a local area network (LAN) 12 to communicate information with each other and with other networked devices. LAN 12 is supported by a plurality of switches 14 and server information handling systems 16. Server information handling systems 16 coordinate access by client information handling systems 10 to stored information and network applications, such as security and word processing applications or more enterprise-specific applications like accounting applications. Enterprise information is stored in a variety of topologies. One example of an enterprise storage topology is direct attached storage (DAS) 18, which includes storage devices, such as hard disk drives, that attach directly to server information handling system 16 without an intervening storage network. Another example of an enterprise storage topology is a storage area network (SAN) that has a SAN server information handling system to coordinate access with networked storage devices 22. SAN topologies include non-redundant topologies and redundant topologies, which include redundant components to compensate for a failure of a component, such as multiple switches 14 and multiple storage devices 22. Storage devices interface through a variety of components, such as iSCSI or Fibre cables, various storage device processors and host bus adapters (HBAs). One difficulty faced by an enterprise when purchasing a networked information handling system enterprise solution is ensuring compatibility of the components used to build the solution, such as hardware and software components within client information handling systems 10, server information handling systems 16 and storage solutions like direct attached storage 18 and storage area network information handling system 20. Enterprise solutions include such hardware components that require compatibility as well as solution line items which do not tie directly to products and options, such as interconnect cables and enterprise software applications.

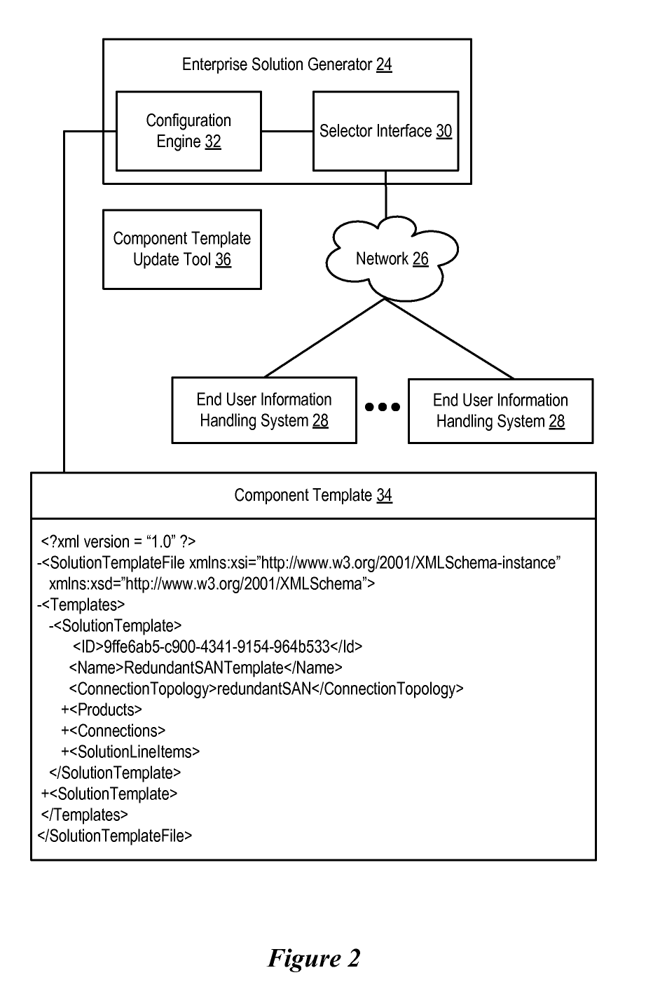

Referring now to FIG. 2, a block diagram depicts a system for generating enterprise solutions from a component template. Enterprise solution generator 24 accepts inputs through a network 26, such as the Internet, from end user information handling systems 28 in order to automatically generate enterprise networked information handling system solutions. A selector interface 30 presents components, options and constraints to end user information handling systems 28 and accepts end user inputs, such as through a graphical user interface. A configuration engine 32 accepts the end user inputs and applies the end user inputs to component information in a component template 34, such as an XML structure, to generate an enterprise solution having plural interconnected information handling systems. Component template 34 is updated with a component template update tool 36 that allows additions, deletions and edits to components and constraints stored in the XML structure of component template 34. For example, updating a solution template with more specific product and option information is done with a series of algorithms crafted as look up tables to ensure updates across related items. The updated component template interlocks with other applications to generate enterprise solutions so that generation of an enterprise solution is performed by related applications that aid in validation of a proposed configuration.

Component template 34 supports generation of an enterprise solution from user inputs for desired components or constraints. For example, an end user can input a desired network or connection topology to locate components associated with the desired network or connection topology, such as a direct attached storage topology, non-redundant storage area network topology or redundant storage area network topology. As another example, an end user can input a product class or preferred product, such as servers, switches, HBAs, and flat panel televisions. Alternatively, an end user can input option criteria as constraints, such as hard disk drive capacity and processor speed. The end user product and option selection criteria are provided to configuration engine 32 to find solutions that best match the criteria, such as an ordered list of solution or solution elements that are selectable by the end user. Describing components in an XML structure to have attributes as opposed to specific product identifiers, such as SKUs, provides easier updates to the components while maintaining a valid component template. For example, a server information handling system might have attributes like a CPU_COUNT or MAX_MEMORY that are associated with CPU and memory requirements for other components or topologies. User inputted products, options and constraints are applied along with component template products, options and constraints to resolve an enterprise solution of plural interconnected information handling systems. For example, selection of an HBA option for a server information handling system component results in selection of cables, such as Fibre or iSCSI cables, based on the attributes of the HBA in the component template and the selected topology.

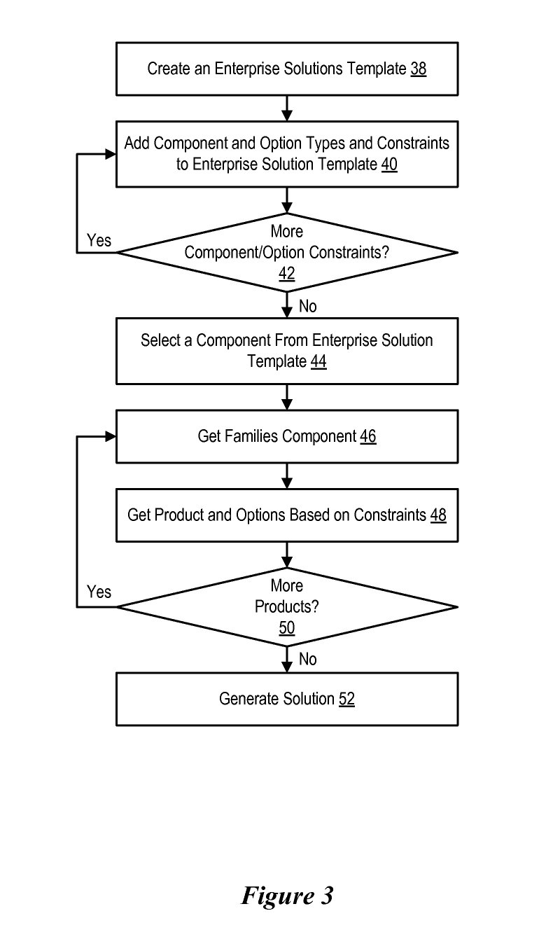

Referring now to FIG. 3, a flow diagram depicts a process for generating enterprise solutions from a component template. The process begins at step 38 with creation of an enterprise solution template. At step 40, component and associated option types and related constraints are added to an XML schema for an enterprise solution template. For example, a server information handling system and interconnections related to the server information handling system are added along with constraints associated with the server information handling system and interconnections. At step 42, a determination is made of whether to add more component or option types or constraints. If yes, the process returns to step 40 to continue populating the XML schema. If no, the process continues to step 44 to select a component from the enterprise solution component template, such as a selection by an end user of a desired component for the end user to include in an enterprise solution. At step 46, the families of components associated with the selected component are retrieved, such as by finding an associated attribute from the XML structure. At step 48, components and options are selected from the available families of components based on constraints input by the end user and associated with the XML structure. At step 50, a determination is made of whether to get additional components. If yes, the process returns to step 46 to retrieve associated families of components. If no, the process continues to step 52 to generate an enterprise solution based on the selected components, options and constraints.

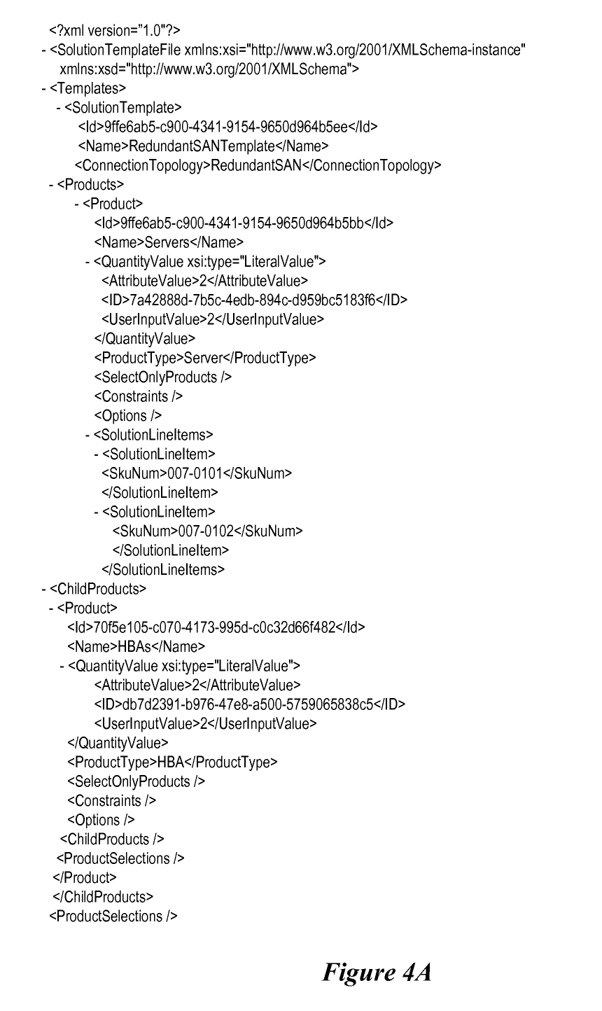

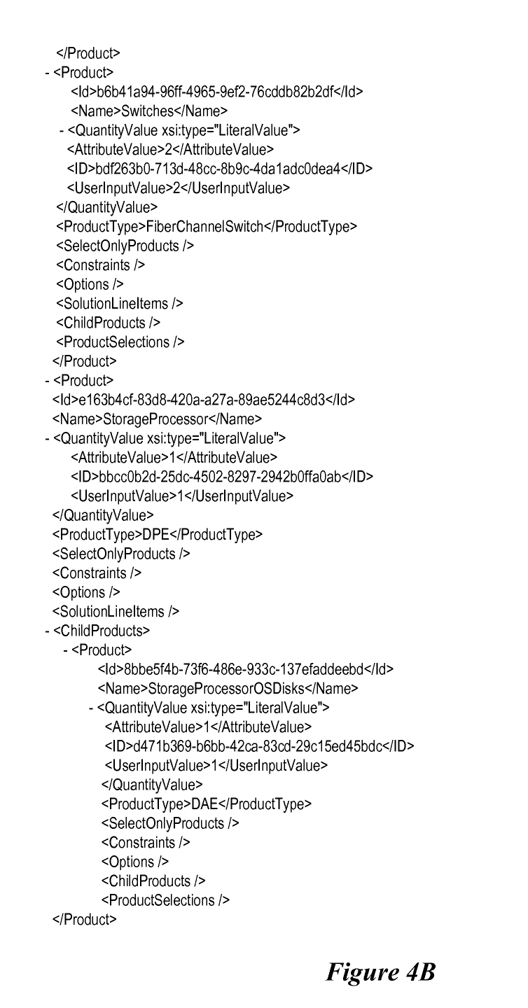

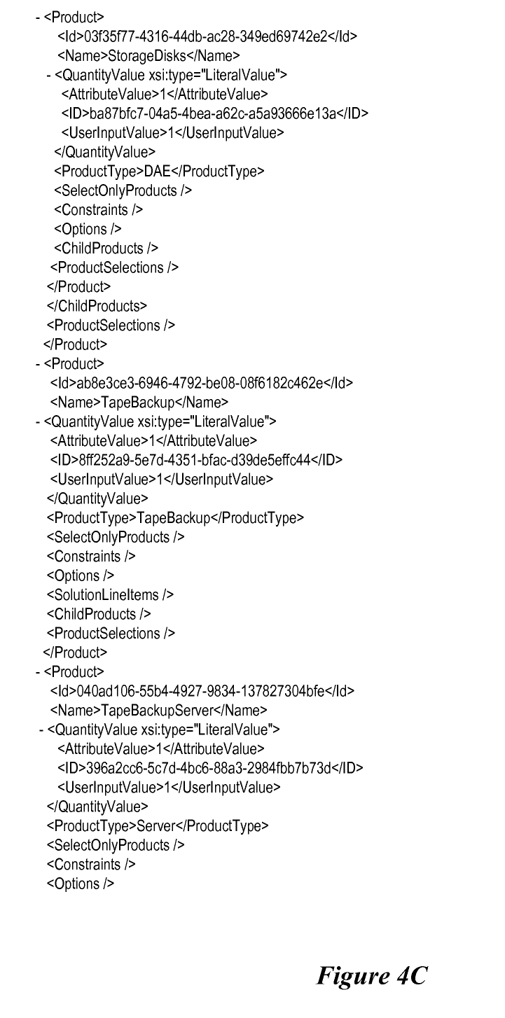

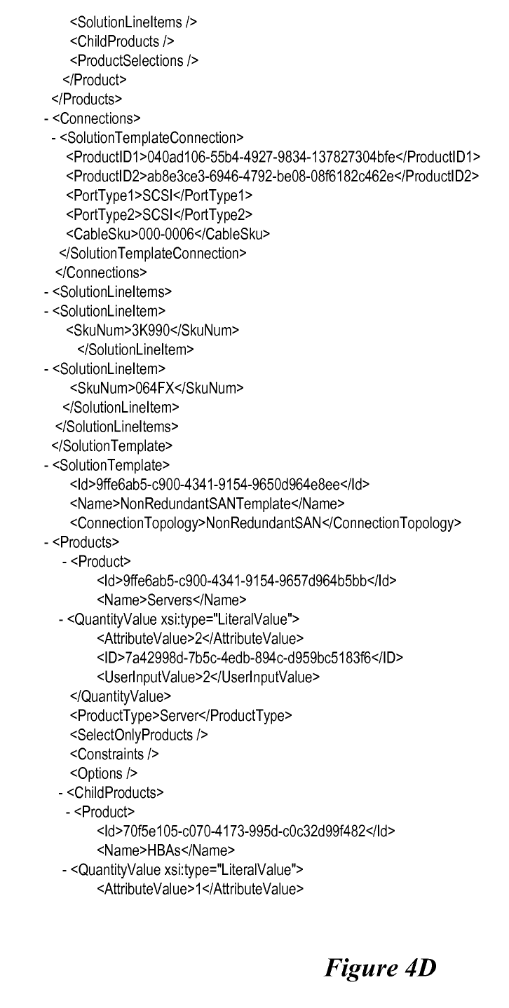

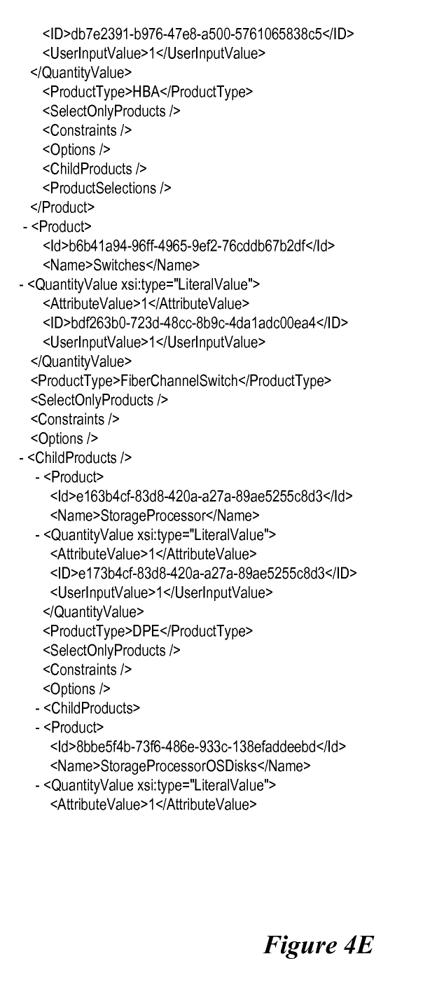

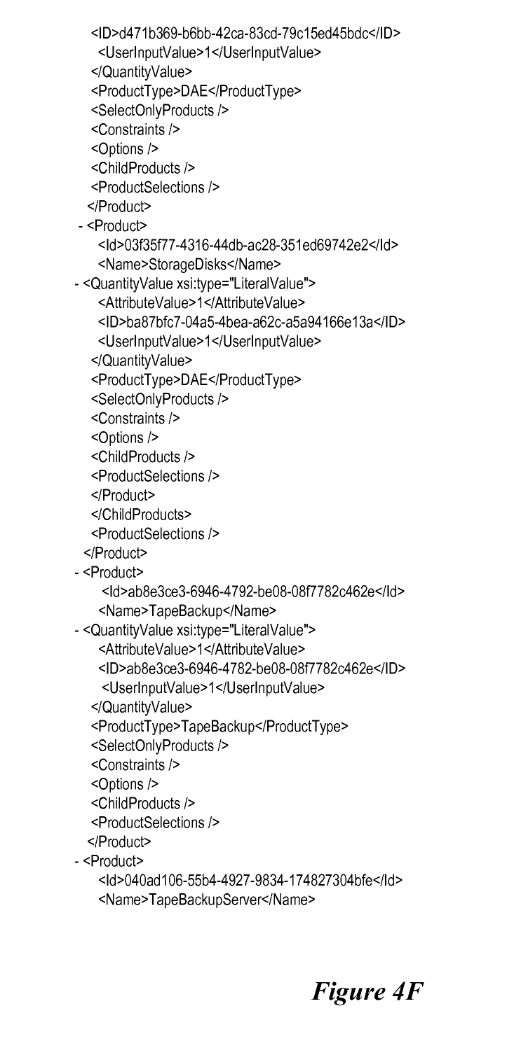

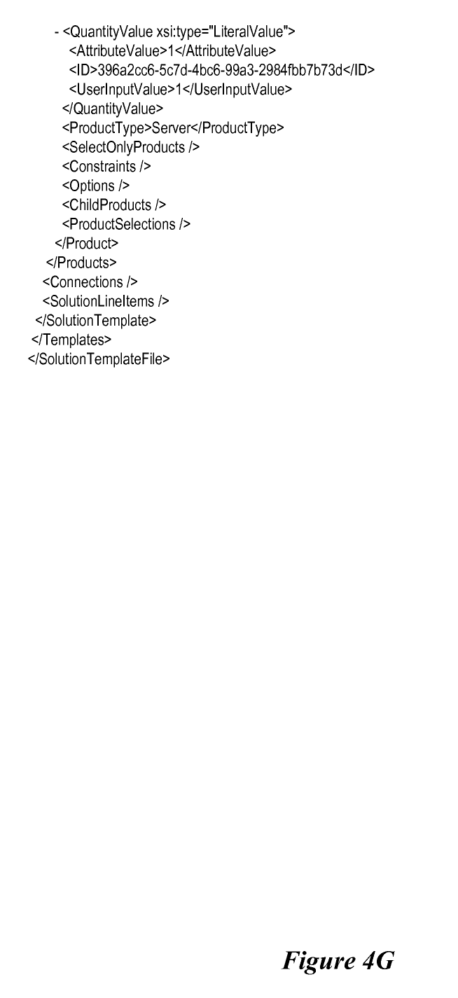

Referring now to FIG. 4, an example of an XML schema for a component template is depicted. Components include server information handling systems and options that are selectable for use with server information handling systems. Attributes for a component product identify options available for the component and constraints applicable to the component. The XML schema adapts to allow the addition, removal or modification of components and their attributes so that an end user can select components for use in configuration of an enterprise solution. Relating components by attributes in an XML schema supports generation of a configuration of an enterprise networked information handling system solution having plural interconnected information handling systems with compatible components.

Although the present invention has been described in detail, it should be understood that various changes, substitutions and alterations can be made hereto without departing from the spirit and scope of the invention as defined by the appended claims.

What is claimed is:

1. A system for configuring networked enterprise information handling system solutions from plural components, the system comprising:
a selector interface operable to accept end user component selections from plural available components;
a component template having the plural components, each component having one or more attributes, at least some attributes defining constraints for at least some components; and
a configuration engine operable to automatically apply the components selections and the constraints to define an enterprise solution.

2. The system of claim 1 wherein the component template comprises an XML template.

3. The system of claim 1 further comprising a component template update tool operable to edit the components and attributes of the component template.

4. The system of claim 3 wherein the component selection comprises an HBA option for the server information handling system, the HBA option having an interconnection constraint.

5. The system of claim 1 wherein the component selection comprises a storage topology and the configuration engine applies the storage topology to define an enterprise solution having components with attributes compatible with the storage topology.

6. The system of claim 5 wherein the storage topologies comprise direct attached storage, storage area network nonredundant fabric and storage area network redundant fabric.

7. The system of claim 1 wherein the enterprise solution comprises plural components having plural interconnections.

8. The system of claim 1 wherein the interconnection devices comprise Fibre Channel cables and iSCSI cables.

9. A method for configuring a networked enterprise information handling system solution, the method comprising:
defining plural components in a components template, each component having one or more attributes at least some attributes defining constraints for at least some components;
accepting component and constraint inputs from an end user;
automatically applying the component and constraint inputs to define an enterprise solution having plural interconnected information handling systems.

10. The method of claim 9 wherein accepting component and constraint inputs further comprises accepting a storage topology for the enterprise information handling system solution.

11. The method of claim 10 wherein the storage topology comprises a nonredundant storage area network topology.

12. The method of claim 10 wherein the storage topology comprise a redundant storage area network topology.

13. The method of claim 10 wherein the storage topology comprises a direct attached storage topology.

14. The method of claim 9 further comprising:
interfacing with the components template with a graphical user interface; and
updating components and constraints through the graphical user interface.

15. The method of claim 14 wherein the components template comprises an XML structure.

16. The method of claim 9 wherein the component and constraints comprise a server information handling system having a constrained number of CPU types and a minimum memory size.

17. A system for managing networked enterprise information handling system solution components for use in configuring networked enterprise information handling system solutions, the system comprising:
a component template having the plural components, each component having one or more attributes, at least some attributes defining constraints for at least some components;
a configuration engine operable to automatically apply component selections and the constraints to define an enterprise solution; and
a component template update tool operable to edit the components and attributes of the component template.

18. The system of claim 17 wherein the component template comprises an XML structure and the components comprise plural storage devices, each storage device having an associated storage topology constraint.

19. The system of claim 18 wherein the storage topology comprises a redundant storage area network and the constraints comprise a plurality switches to provide redundancy.

20. The system of claim 18 wherein the storage topology comprises direct attached storage.
